(19) United States
(12) Patent Application Publication
(10) Pub. No.: US 2026/0268347 A1
(43) Pub. Date: Sep. 10, 2026

(54) Generating Unique Identifiers from a Collection of Particles

(71) Applicant: DUST Identity, Inc., Newton, MA (US)

(72) Inventors: Ophir Gaathon, Needham, MA (US); Jonathan Hodges, Princeton, NJ (US); Sinan Karaveli, Princeton, NJ (US)

(73) Assignee: DUST Identity, Inc., Newton, MA (US)

(21) Appl. No.: 19/556,442

(22) Filed: Mar. 4, 2026

Related U.S. Application Data
(63) Continuation of application No. PCT/US2024/046864, filed on Sep. 16, 2024.
(60) Provisional application No. 63/582,993, filed on Sep. 15, 2023.

(51) Int. Cl. G06Q 30/018; G06K 7/14

(52) U.S. Cl. CPC G06Q 30/0185; G06K 7/1404

(57) ABSTRACT

In a general aspect, a unique marker includes a plurality of particles. In some cases, the particles are distributed (e.g., fixed) on a surface, and a unique code can be generated based on the spatial properties (e.g., relative positions and relative orientations) of the projection of these particles onto a plane. A computing system may generate the unique code, and the spatial properties may be determined from data obtained by a camera or another type of optical detector.

### CROSS-REFERENCE TO RELATED APPLICATIONS

This application claims priority to U.S. Provisional App. No. 63/582,993, filed Sep. 15, 2023, entitled “Generating Unique Identifiers from a Collection of Planar Bodies,” the entire content of which is hereby incorporated by reference.

### BACKGROUND

The following description relates to generating unique identifiers from a collection of particles.

Some products are produced with holograms, watermarks, fluorescent dyes, or other features that can be used as anti-counterfeiting measures. For example, such features may be used to verify the source or authenticity of products. Such measures are important in a number of industries, including the food industry, the pharmaceutical industry, the electronics industry, the luxury goods industry, and others.

### DESCRIPTION OF DRAWINGS

FIG. 1 is a schematic diagram, in top view, of an example group of particles that can be utilized in a unique marker for a target object.

FIG. 2 is a schematic diagram, in perspective view, of an example group of particles affixed to the planar surface of a target object using a medium.

FIG. 3 is a schematic diagram, in top view, of an example group of particles in which each particle has an exterior perimeter that defines either a convex or concave polygonal shape.

FIG. 4A is a schematic diagram, in top view, of an example particle having a set of internal orthogonal axes that includes major and minor axes.

FIG. 4B is schematic diagram, in top view, of example particles of different sizes.

FIG. 5 is a schematic diagram, in elevation view, of two example arrangements of object and image planes that can be used to derive a unique identifier.

FIG. 6 is a schematic diagram, in cross-section view, of two example groups of particles that are affixed to, respectively, a convex surface and an undulating surface.

FIG. 7 is a schematic diagram, in top view, of an example shape having a set of principal orthogonal axes that includes major and minor axes.

FIG. 8 is a schematic diagram, in top view, of example shapes each having a set of principal orthogonal axes that includes major and minor axes.

FIG. 9 is a schematic diagram illustrating relative distance and relative orientation between a pair of shapes defined by particles.

FIG. 10 is a schematic diagram illustrating shapes defined by a particle based on different perspectives.

FIG. 11 is a schematic diagram illustrating shapes defined by multiple particles based on different perspectives.

FIG. 12 is a flow chart illustrating an example process for determining a unique code based on one or more images of an object that includes particles.

FIG. 13 is a flow chart illustrating an example process for determining shape information based on one or more images of an object that includes particles.

FIG. 14 is a flow chart illustrating an example process for determining relative position and relative orientation information for a pair of planar particles.

FIG. 15 is a flow chart illustrating an example process for determining two unique codes based on one or more images of an object that includes planar particles each having sub-elements.

FIG. 16 is a block diagram showing an example device.

### DETAILED DESCRIPTION

In some aspects of what is described here, techniques are disclosed for generating one or more unique identifiers (also referred to here as a unique code or authentication code) from one or more images of an object that includes a plurality of particles (e.g., planar particles, planar bodies, planar elements, or elongated particles).

In a general aspect, a unique marker can include particles disposed on a surface. In some cases, the particles are disposed on the surface of a target object, and the particles have well-defined relative positions and orientations on the surface. The particles may be physically part of a unique marker that provides the basis to generate a unique identifier of the target object. Moreover, deriving a two-dimensional representation of the particles may reduce the overall dimensionality of the group, for instance, such that a camera or other imaging device can easily discern the unique set of relative positions and orientations in the unique marker. The reduced dimensionality may therefore allow the unique identifier to be readily determined from the unique marker without more sophisticated measuring devices. In some variations, the unique identifier may be determined using an imaging device, such as an optical imaging device (e.g., camera, a stereographic camera, or mobile phone) or other device used for imaging (e.g., such as devices using X-rays or millimeter-waves).

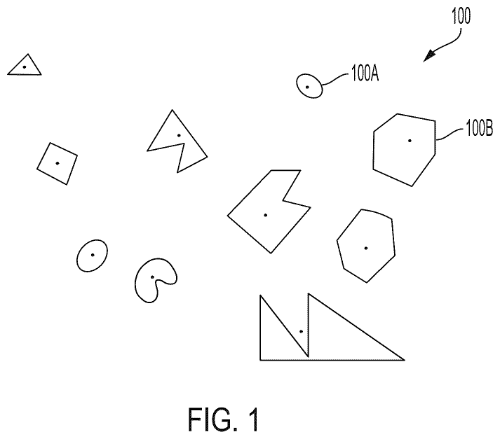

In some implementations, the particles have high aspect ratios, such that each particle can be considered (or approximated as) a two-dimensional geometric object. For instance, each particle may have physical extents that occur predominantly in two dimensions. In some cases, the thickness or depth of a particle is negligible relative to the size of the particle in either of the two primary dimensions. For instance, the thickness of a particle may be less than 10%, less than 5%, or less than 1% of the particle's size in the two other dimensions. In some cases, a particle has surface features (e.g., bumps, etc.) or surface variations (e.g., cracks, etc.) that are negligible relative to the size of the particle in either of the two primary dimensions. In some cases, a particle may curve or bend along one or both of the two primary dimensions. In some cases, the particles may include flakes, chips, shavings, foils, strips, slivers, flecks, and so forth. Combinations of different types of particles are possible. FIG. 1 presents a schematic diagram, in top view, of an example group of particles 100 that can be used as a unique marker for a target object. Some of the particles (e.g., 100A, 100B) have exterior perimeters that define a polygon or another two-dimensional geometric shape.

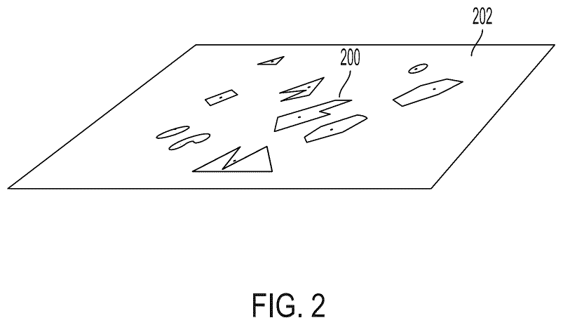

In some implementations, a medium (host material) is used to affix the particles —or unique marker containing the particles—to the surface of the target object (e.g., an adhesive). The medium may be thin or thick transparent or semi-transparent material, and the surface of the target object may be a planar surface (or locally planar surface). However, other surfaces are possible for the target object (e.g., a curved surface, an arbitrarily shaped surface, etc.). FIG. 2 presents a schematic diagram, in perspective view, of an example group of planar particles 200 that is affixed to the planar surface of a target object using a host material 202.

In some implementations, the particles are affixed to the surface of a target object using a thin media. The surface may be a planar surface or a locally planar surface. In this case, the particles may conform to a topology of the surface, and as such, the relative positions and orientations of the particles may occur in two spatial dimensions. The resulting unique set of relative positions and orientations may therefore be given with respect to a single two-dimensional coordinate system.

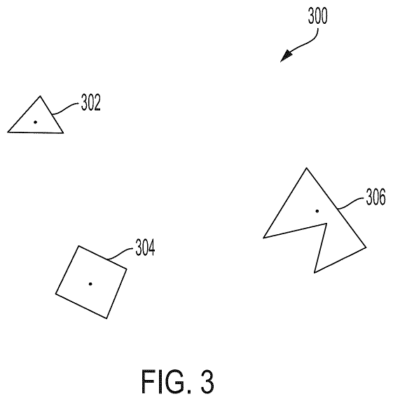

In some implementations, one or more of the particles in a group may have exterior perimeters when imaged that define a polygonal shape, such as a closed polygon. To do so, the exterior perimeters may include straight or curved exterior surfaces. The polygonal shape may be convex or concave in nature, and each shape may contain a centroid (geometric center) coordinate in two-dimensions. For example, the polygonal shape may include a geometric center coordinate that is defined by a center of mass in an xy plane. FIG. 3 presents a schematic diagram, in top view, an example group of particles 300 in which each particle (e.g., 302, 304, 306) has an exterior perimeter that defines either a convex or concave polygonal shape. In these implementations, the relative distances between any two particles, or the relative angles and distances between three or more particles, may represent a unique signature that can define the spatial relationships between the center coordinates of the particles (e.g., center of masses of the particles).

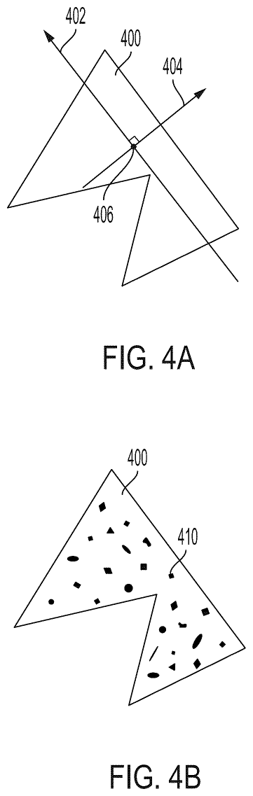

Moreover, each particle in the group when imaged and defined as a polygon shape may be fit with a set of internal orthogonal axes such that a single rotation angle can relate the orientation of one set of internal orthogonal axes to another. In some variations, such as shown in FIG. 4A, the set of internal orthogonal axes (e.g., 402, 404, which form a right angle as indicated by the right angle symbol) can include major and minor axes. For example, a moment calculation may be used to derive the set of internal orthogonal axes for a shape (e.g., 400). In these cases, the major axis (e.g., 402) may coincide with a calculated major moment of the shape, and the minor axis (e.g., 404) may be constructed orthogonal to an axis that is nearest a calculated minor moment of the shape. The major and minor axis may have an origin at a centroid (e.g., 406) of the shape. In many variations, the relative orientation between two shapes can be represented by a single in-plane angle that can transform the coordinate system (or set of internal orthogonal axes) of one particle to that of another.

In some implementations, the particles define a unique set of relative positions and orientations that is three dimensional. For example, a group of particles may be affixed to a surface of a target object using a thick media (as host material). As another example, a group of particles may be affixed to a non-planar surface of a target object. In these implementations, the position of each particle can be represented by a centroid (e.g., center of mass) that is defined in three spatial dimensions. For example, for two particles having centroids at different depths in the thick media, the depth difference can be represented in a third spatial dimension (e.g., where horizontal and vertical position differences between the centroids are represented in the first and second spatial dimensions). The orientation of each particle may also be represented in three spatial dimensions by a coordinate system local to the particle. The local coordinate system can, for example, be defined by a vector normal to a planar surface of the particle as well as major and minor axes that are based on a shape of the particle. The relative distances between any two particles and the coordinate transformations between any two particles can provide a unique signature that contributes to or defines the spatial characteristics of a unique marker. Other combinations of spatial relationships are possible. For example, the distances between three or more particles and the coordinate transformations between each particle and a common reference frame can also provide a unique signature that contributes to or defines the spatial characteristics of the unique marker.

The particles can be from different classes and can also be used at varying scales or sizes to create a composite unique marker (e.g., a fingerprint or signature). In some implementations, a characteristic size of a class is centimeter scale, millimeter scale, or other size scale. In some implementations, characteristic size of a particle class represents a minimum, a maximum, or an average expected size along one or more dimensions of a particle. For instance, a given particle that is larger in one dimension than a threshold established with respect to a characteristic size (e.g., 5 mm for a millimeter scale) can be excluded from being considered part of a class having that characteristic size. For example, a unique marker may include a first class of particles that are on average 1 cm×1 cm in characteristic size and a second class of particles that are on average 0.1 mm×0.1 mm in characteristic size. In this configuration, the first and second classes can be used to generate, respectively, first and second unique identifiers. In some examples, the second class includes particles or elements that are not necessarily planar. The first and second classes can also be used collectively to generate a third unique identifier (e.g., a multiscale authentication code). Moreover, these particles can also be combined with extended three-dimensional particles, such as described in Intl. Pat. Pub. No. WO 2017/155967 entitled “Generating a Unique Code from Orientation Information” and as described in Intl. Pat. Pub. No. WO 2021/092121 entitled “Applying and Using Unique Unclonable Physical Identifiers”. For example, microscopic diamond particles can be added to a host material with a group of planar particles (e.g., glitter flakes) to create a multiscale unique marker, whereby each class corresponds to a unique marker (e.g., a fingerprint) that can be used to generate a unique identifier.

FIG. 4B illustrates example particles of different sizes. Example particle 400 includes (on its surface) a plurality of particles 410 of a different class that are part of a multiscale unique marker. For example, generating a first unique identifier can be performed using relationships between a plurality of shapes representing particle 400 and other particles of similar scale with respect to each other (e.g., 100A and 100B). In this example, generating a second unique code can be performed using a plurality of particles of a different scale (e.g., smaller than particle 400), including particles 410, with respect to each other. In some cases, the second unique code is derived from relationships between sub-particles (e.g., particles 410) that are located on the same particle (e.g., particle 400). In some cases, the second unique code is derived from relationships between sub-particles located on two or more other particles (e.g., relationships between sub-particles (e.g., of similar scale as particles 410) located on the surface of different particles such as 400, 100A, and 100B). In some cases, the particles and sub-particles can exist independently in the medium, with the first and second codes derived from their respective particle classes.

The same or different techniques can be used to derive information (and thus unique codes) from different classes of particles. For example, particles in each class can respond differently to imaging or sensing in different ways. In some implementations, the particles can reflect electromagnetic radiation in a manner that is dependent on the polarization vector of the propagating electromagnetic field. In these implementations, classes of particles may be distinguished by the relative reflectance of the particles at a particular angle of illumination and polarization. For instance, classes of particles may be distinguished by illuminating them with electromagnetic radiation (e.g., in the visible spectrum) and observing them with optical imaging and a polarization filter. In some instances, the particles might also be birefringent. The reflection of both polarized and unpolarized optical illumination can also have a strong dependence on the angle of incidence of the illumination, relative to the viewing angle. In some variations, the particles may include holographic patterns encompassing some of the aforementioned optical characteristics. The particles may also have different colors (e.g., absorption characteristics) or be engineered to have electromagnetic spectral responses (e.g., optical filters) in the visible, UV, infrared, or THz regimes.

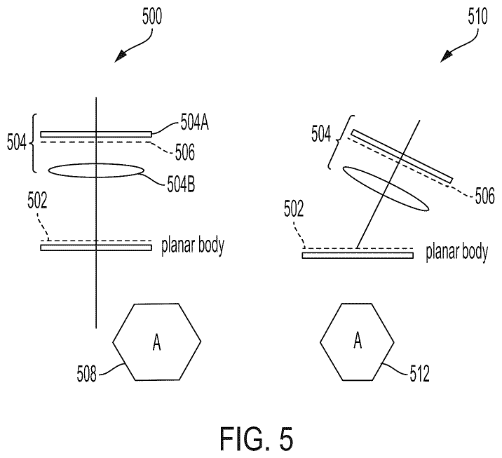

In deriving a unique identifier from a group of particles, a series of techniques may be deployed. For example, the group of particles—or a unique marker containing the group—can be imaged using an object plane and an image plane (also referred to as an imaging plane). The group of particles resides in the object plane, and the image plane corresponds to a plane of an imaging device (e.g., a camera) where the particle is sensed or imaged. FIG. 5 presents a schematic diagram, in elevation view, of two example arrangements of object and image planes that can be used to derive a unique identifier.

As shown by the left side 500 of FIG. 5, the object and sensor planes may be parallel to each other (e.g., object plane 502 is parallel to image plane 506). The image taken by the imaging device 504 (e.g., which includes imaging unit 504A and optical magnifier 504B) in this case may include pixel locations that can be related to locations in the unique marker by a magnification factor, modulo image artifacts, and so forth. Note that the depiction of imaging device 504 (e.g., and imaging unit 504A and optical magnifier 504B) in FIG. 5 is merely illustrative and not necessarily to scale (e.g., the size and or distance between components of imaging device 504, or between components of imaging device and an object or particle, can differ from the depiction in FIG. 5). Shape 508 illustrates the shape of a particle taken by imaging unit 504 when image plane 506 is parallel to object plane 502. However, the imaging device 504 may also occupy a position (or pose) that makes the image plane 506 non-parallel to the object plane 502, as shown by the right side 510 of FIG. 5. Shape 512 illustrates the shape of the particle (the same particle of shape 508) in an image taken by imaging unit 504 when image plane 506 is oriented as shown in right side 510 (e.g., not parallel to object plane 502). Notably, shape 512 is skewed relative to shape 508 due to the pose of the image device 504 when capturing the image. If the pose of the imaging device 504 is known relative to the parallel arrangement (e.g., an angle representing the rotation of image plane 506 in right side 510 relative to image plane 506 in left side 500), distortions to the image (e.g., distortion of shape 512, as compared to shape 508) relative to the parallel arrangement can be used to correct for the pose and derive a unique identifier that is similar to the parallel arrangement. In some variations, the pose can be derived by taking a series of images and deriving a structure of the pose change from those images, thereby ascertaining the parallel arrangement (e.g., structure from motion). The pose change may also use external sensors, such as inertial measurement units, gyroscopes, and so forth, to aid in reconstruction of the image-to-object-plane relationship.

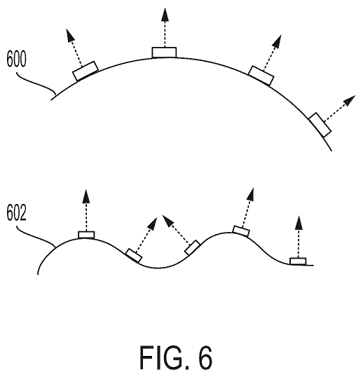

In some implementations, the particles reside on a rectilinear surface and the corresponding unique set of positions and orientations is based on one or more rectilinear spatial relationships. In other implementations, as shown in FIG. 6, the particles reside on a curved surface (e.g., 600) or a surface (e.g., 602) that has a generic convex or concave topology with only local curvature (e.g., an undulating surface). In these implementations, the spatial relationships of the particles may include a third dimension or second angle parameterization that can be used to derive the unique set of positions and orientations between the particles.

In some aspects of what is described here, a unique and unclonable physical identifier may be derived and used. The unique and unclonable physical identifier may be based on a unique marker that includes elements, such as a group of particles. In some implementations, a unique marker is shaped to a morphology of a target object's surface feature. The surface feature can be facets, surface patterns, textures, or other indentations of the object. In some instances, the target object has multiple sides or faces, and a facet can be one of the multiple sides or faces of the object. For example, the target object can be a gem, and a facet can be one of the multiple sides or faces of the gem. The unique marker can be applied to or incorporated into the target object (which may also be referred to as an article).

In some implementations, the unique marker may include elements distributed in or on a host material that is applied to or incorporated into the target object. In some cases, the elements are distributed over a single plane on the target object. In some cases, instead of residing in a single plane, elements are suspended in a host material at differing depths. In these cases, to accommodate imaging, the high aspect ratio of the mean element separation in the host material can be arranged such that the variation of the depths of the elements are small with respect to the overall extent of the group of the elements. In some cases, an imaging system captures a two-dimensional projection of a three-dimensional narrow film of element distribution. In some variations, the elements of the unique marker may include crystalline particles (e.g., micron-scale or nano-scale diamond particles) or other types of particles. The unique marker can be physically unclonable, thus allowing the unique marker to be a taggant for the object. For example, the orientations of the elements may be randomly distributed, and the element sizes and relative positions can be regular or randomly distributed. In some examples, making a copy of the target object having a marker with a similar composition and orientation of elements is sufficiently unlikely such that the target object having the unique marker can be considered distinct or singular and therefore can be considered unique and physically unclonable. In some instances, the unique marker is a sticker that includes a distribution of elements on a substrate having an adhesive backing, and at least a portion of the sticker is applied to an object.

The unique marker can be used to analyze the target object. In some examples, analyzing the target object using the unique marker includes authenticating the identity of the target object, determining whether the target object has been tampered with, determining whether the target object has been used or activated, determining whether the target object has been exposed to environmental stress, determining whether the target object has been subjected to mechanical stress or wear, or other types of analysis of the target object. Various types of target objects can be analyzed using the methods and systems discussed herein. Non-limiting illustrative examples of target objects include bank notes and certificates, credit cards and alike, electronic payment systems, voting systems, communication systems and elements, jewelry and collectables, diamonds and gems, packaging, paper products, electronic equipment cases, electronic components and systems (e.g., integrated circuits, chips, circuit boards), retail goods (e.g., handbags, clothing, sports equipment), industrial components and systems (e.g., machine parts, automotive parts, aerospace parts), raw materials (processed or unprocessed) (e.g., ingots, billets, logs, slabs), food products and packaging (e.g. wines, spirits, truffles, spices), pharmaceuticals, pharmaceutical packaging and lots, medical devices and surgical tools and their packaging, official documents (e.g., contracts, passports, visas), digital storage systems and elements, mail and postal packaging, seals and tamper-proof labels. This list of example target objects is not exhaustive, and many other types of target objects can be analyzed.

In some aspects of what is described here, a unique identifier (or code) can be generated based on the elements of the unique marker. In some instances, one or more properties of the elements can be determined (e.g., by scanning the elements) to generate the unique identifier, which can then be used, for example, to analyze the object. For instance, the spatial orientations, locations, or sizes of the elements may be extracted from the unique marker to generate a unique identifier, although other types of properties of the elements may be used to generate the unique identifier. The unique identifier can be used to analyze the object in a similar way as barcodes and quick-response (QR) codes are currently used to readily identify objects. Therefore, the unique marker may be used as a “fingerprint,” for instance, when attached to or incorporated into the target object, enabling the object to be analyzed.

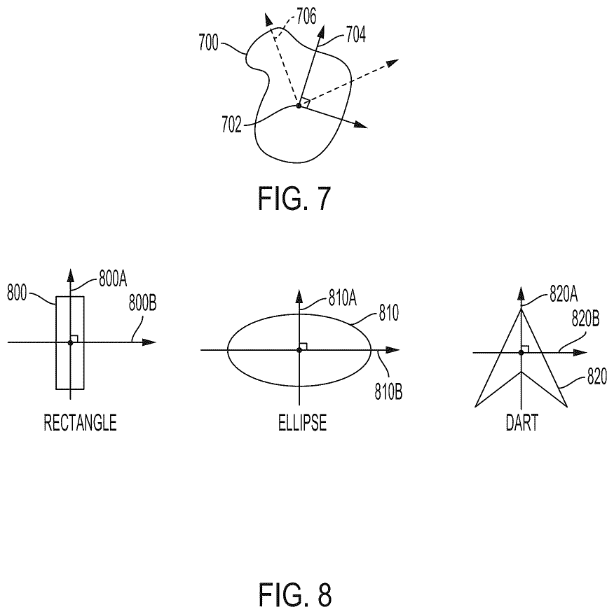

FIG. 7 is a schematic diagram, in top view, of an example shape having a set of principal orthogonal axes that includes major and minor axes. In FIG. 7, shape 700 is defined by a border. In this example, shape 700 is derived from a planar image that includes a planar representation of a particle (e.g., a planar particle or an elongated particle). In some implementations, the planar representation of the particle is a two-dimensional representation of the particle. For example, the planar representation of the particle is a region within the image (e.g., defined by borders of the depiction of the particle in the image). In some implementations, the region of the image is formed by (or can be considered) a projection of a view (e.g., captured by an imaging device) of the particle onto a plane (e.g., image plane or object plane). For example, shape 700 can represent a region corresponding to (e.g., defined by) a particle that was imaged by an imaging device using an image plane in parallel with an object plane. FIG. 7 illustrates centroid 702 determined for shape 700, which is the origin for two sets of axes shown. Axes 704 (solid lines) represent an arbitrarily defined set of orthogonal axes (e.g., which may be defined relative to, or aligned with, a global set of axes defining a reference coordinate system). Axes 706 (dotted lines) represents orthogonal principal axes that have been determined based on geometric information about shape 700.

In some implementations, a particle is a planar particle. In some implementations, a planar particle shape is a particle defined primarily in two dimensions (e.g., length, width); a third dimension (e.g., thickness) is insubstantial (e.g., less than 20%) relative to the other two dimensions. Examples of planar particles can include flakes, foils, plates, wafers, discs, leaves, and chips.

In some implementations, a particle is an elongated particle. In some implementations, an elongated particle is a particle defined primarily in one dimension (e.g., length); second and third dimensions (e.g., width, thickness) are insubstantial relative to primary dimension. Examples of elongated particles can include rods, cones, wires, nano-wires, fibers, filaments, and needles. In some implementations, an image that depicts a view of the elongated particle projected onto an image plane includes a planar representation of the elongated particle (e.g., due to the elongated particle not being perfectly one-dimensional).

In some implementations, principal axes are determined by calculating a centroid of a shape, calculating second moments of area of the shape with respect to the centroid, and diagonalizing a default coordinate system to get the principal axes of the element.

In some implementations, to calculate the centroid of the shape, an arbitrary point within the interior of the shape as selected as the reference origin. The shape exists in a plane and two orthogonal axes are defined (which will be referred to as x and y); the centroid coordinate is found for each of these directions. For a displacement x from the reference origin, along the x axis, with a small area slice dA, the product of this displacement and the area slice is calculated, and a sum is taken of all of these products with respect to the origin. Here dA=I(x, y)dxdy where I(x, y) is 1 if point (x, y) is inside the shape and 0 if outside of the shape. This process is repeated for the orthogonal displacement y, along the y axis, by taking a small area slice dA as well. Taking the sum of all of the products x*dA in the x direction—this value is referred to as Sₓ. Then the centroid for x, call this Cₓ, is Sₓ/A where A is the total area of the shape. This centroid is defined with respect to the origin. Likewise, the centroid for the y direction is C_{y}, and is S_{y}/A, calculated also with respect to the origin.

In some implementations, the centroid is the center of mass or center of area of the shape. In some implementations, the centroid is on the interior of the shape. For example, for convex shapes the centroid will be located within the shape boundary. In some implementations, the centroid is on the exterior of the shape. For example, the centroid of a shape need not lie in the interior of the shape. For instance, certain shapes, such as a ring or annulus or dart shape, can have the centroid position outside the boundaries of the shape.

In some implementations, the second moments of area (also known as area moment of inertia) of the shape with respect to the centroid are determined. In some implementations, to calculate the second moments of area of a shape, the centroid location is found, which is the coordinate in the x,y plane (Cₓ,C_{y}) where the order is of the x and then y coordinates in the orthogonal axis frame used to calculate the centroid location from an arbitrary origin. From the centroid, for each infinitesimal area element dA, the second moment of area for the x axis, Iₓₓ, is calculated as the sum of the products of the infinite area element dA and the displacement along the y axis, y, squared. Similarly, the second moment of area for the y axis is I_{yy} is calculated as the sum of the products of the infinitesimal area element dA and the displacement along the x axis, x, squared. Finally, I_{xy} is calculated as the sum of the products of the infinitesimal area element dA and, the displacement along the x axis, x, and the displacement along the y axis, y. Note that I_{xy}=I_{yx}. A matrix of the values can be defined: I=[[Iₓₓ,I_{xy}], [I_{yx},I_{yy}]] that compactly represents the three values.

In some implementations, a default coordinate system is diagonalized to get the principal axes of the element. For example, given the matrix, I, if the matrix is non-diagonal, there exists a transformation of the axes x and y to x′ and y′ by a rotation in the xy-plane that creates a diagonal version of the matrix I′. The transformation that diagonalizes I, or solves the eigenvalue problem, also gives the principal axes for the shape, where those axes intersect at the centroid of the shape. Diagonalizing I (with the origin at centroid) [[Iₓₓ, I_{xy}], [I_{yx},I_{yy}]] results in [[a,0], [0,b]], where a and b are the eigenvalues, also known as the principal moments of inertia. The corresponding eigenvectors (vₐ and v_{b}) can be found by solving for (I−a)=vₐ and (I−b)=v_{b}, respectively.

FIG. 8 is a schematic diagram, in top view, of example shapes each having a set of principal orthogonal axes that includes major and minor axes. Shape 800 is a rectangle and includes major principal axis 800A and minor principal axis 800B. Shape 810 is an ellipse and includes minor principal axis 810A and major principal axis 810B. Shape 820 is a dart (e.g., arrow) shape and includes major principal axis 820A and minor principal axis 820B.

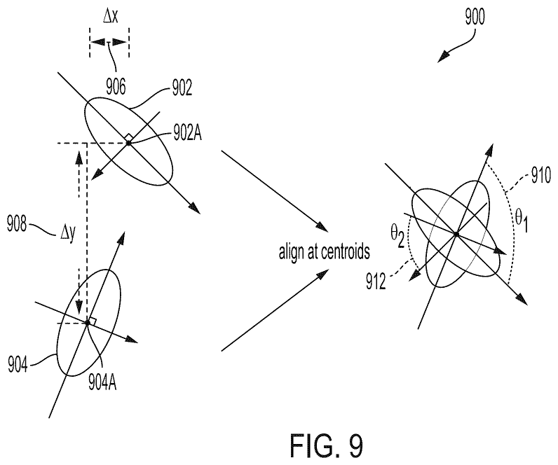

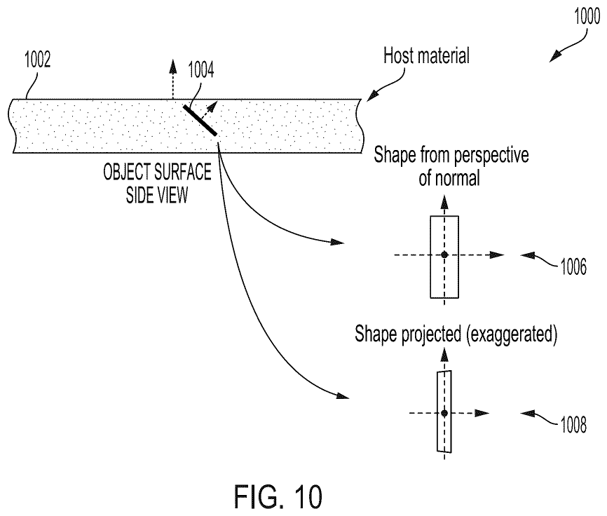

FIG. 9 is a schematic diagram illustrating relative distance and relative orientation between a pair of shapes defined by the planar representations of particles. Diagram 900 in FIG. 9 includes shape 902 and shape 904, each representing a shape derived from different particles in an image of an object. Shape 902 includes centroid 902A and shape 904 includes centroid 904A. The centroids can be defined relative to a reference coordinate system (e.g., of the image or arbitrarily defined) and the displacement between the centroids along one or more axes of the reference coordinate system can be determined. In some implementations the displacement is a single distance value (e.g., straight line distance) between the centroids. As shown in FIG. 9, a displacement between the two centroids in the x-direction is shown by displacement 906 and a displacement between the two centroids is the y-direction shown by displacement 908. The displacement between the two centroids can be used to determine the distance between them or the individual x-component and y-component values can be used to represent a relative distance between the pair of shapes 902 and 904. The relative distance can be used to characterize the relationship between the particles represented by shapes 902 and 904.

Additionally, the relationship between shapes 902 and 904 can be characterized by a relative orientation between them. On the right side of diagram 900 of FIG. 9, shapes 902 and 904 are shown aligned on their centroids. Diagram 900 includes an angle 910 representing a measurement of the rotational displacement between the major principal axes of each shape 902 and 904. Diagram 900 also includes an angle 912 representing a measurement of the rotational displacement between the minor principal axes of each shape 902 and 904. Both or either of angles 910 or 912 can be used as a measure of the relative orientation difference between the shapes 902 and 904 representing particles.

FIG. 10 is a schematic diagram illustrating shapes defined by a particle based on different image plane perspectives. Diagram 1000 of FIG. 10 includes a surface of an object 1002 made up of a polymer host material that includes particle 1004. Diagram 1000 illustrates an implementation in which the particles are planar (e.g. two-dimensional) and are not arranged along a single plane, but rather can be tilted or canted from a plane formed by the surface of object 1002. Diagram 1000 also illustrates the difference between the shapes formed by such a planar particle when imaged along different directions. Shape 1006 has a rectangular shape and is formed when particle 1004 is imaged in a direction along the surface normal of particle 1004 (e.g., the imaging plane is parallel to a surface of particle 1004). Shape 1008 has a trapezoidal (almost rectangular) shape and is formed when particle 1004 is imaged in a direction along the surface normal of object 1002 (e.g., the imaging plane is parallel to the surface of object 1002). Shape 1008 illustrates the shape of particle 1004 when a view of the particle is projected onto an imaging plane formed by the surface (e.g., parallel to) object 1002. Because of how planar particle 1004 (rectangular when viewed from the perspective shown by shape 1006) is oriented (e.g., tilted, rotated) within the host material relative to the image plane, shape 1008 appears trapezoidal.

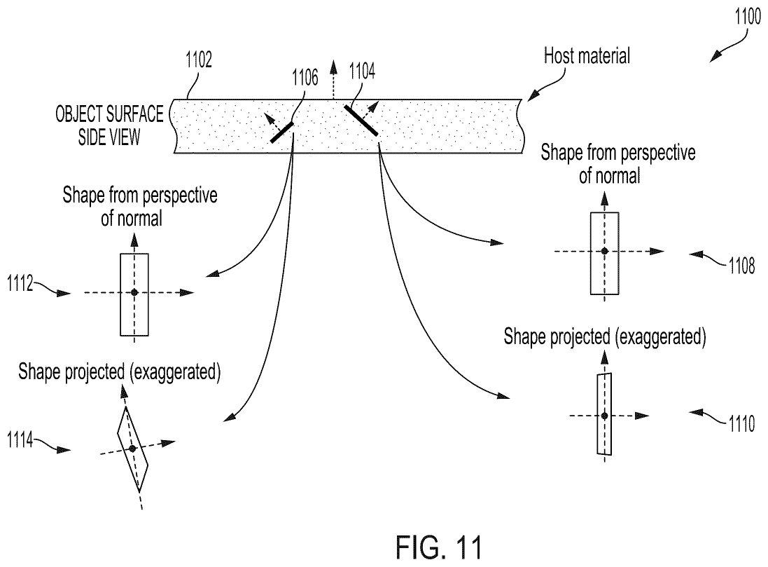

FIG. 11 is a schematic diagram illustrating shapes defined by multiple particles based on different perspectives. FIG. 11 illustrates an example similar to FIG. 10, but having two particles whose thickness is small enough to consider them planar (e.g. two-dimensional). Diagram 1100 of FIG. 11 includes a surface of an object 1102 made up of a polymer host material that includes particles 1104 and 1106. Diagram 1100 illustrates an implementation in which planar particles are not arranged along a single plane, but rather can be tilted or canted from a plane formed by the surface of object 1102 at different depths within the polymer host material. Diagram 1100 also illustrates the difference between the shapes formed by a particle when imaged along different directions. Shape 1112 has a rectangular shape and is formed when particle 1106 is imaged in a direction along the surface normal of particle 1106 (e.g., the imaging plane is parallel to a planar surface of particle 1106). Shape 1108 is rectangular for similar reasons and is formed by imaging particle 1104 (the same particle as particle 1004 in FIG. 10). Shape 1114 has a rhomboidal shape and is formed when particle 1106 is imaged in a direction along the surface normal of object 1102 (e.g., the imaging plane is parallel to the surface of object 1102). Shape 1114 illustrates the shape of particle 1106 when an image of the particle is projected on an imaging plane formed by the surface (e.g., parallel to) object 1002. Because of how planar particle 1106 (rectangular when viewed from the perspective shown by shape 1112) is tilted and oriented within the host material relative to the image plane, shape 1114 appears rhomboidal. Shape 1110 is trapezoidal for similar reasons and is formed by imaging particle 1104. In this example, particles 1104 and 1106 have the same shape when viewed relative to their respective surface normal, but create different shapes (e.g., 1114 and 1110) when projected onto the image plane.

In the example in FIG. 11, an image taken of object 1102 can result in a pair of shapes 1110 and 1114 being determined from the planar views of the particles on the object. As discussed here, information for each shape can be determined, including a centroid and principal axes for each shape. From this information, a relative distance (e.g., relative displacement or relative position) between the centroids is determined and a relative orientation between their principal axes is determined. In some implementations, relative distance and relative orientations are determined (or derived) for multiple pairs of shapes determined from an image of the object. For example, if 50 planar shapes of particles are determined from an image of an object, the number of unique pairs of shapes would be 1,225, which is given by the equation n(n−1)/2 where n is the number of shapes in the set. In such example, for each of the 1,225 unique pairs, a relative distance and relative orientation can be determined (e.g., calculated directly or derived using information known about one or more other shapes or pairs of shapes).

In some embodiments, deriving a relative distance or relative orientation for a first pair is performed by using known values (e.g., already determined). For example, if a centroid location (or principal axis rotation) is known with respect to a reference coordinate system for two shapes individually, a relative distance (or relative orientation) between those shapes can be derived. Similarly, if relative distance (or relative orientation) for two shapes with respect to a third shape is known, relative distance (or relative orientation) between the two shapes can be derived.

In some implementations, relative spatial orientation information (e.g., relative position information and relative orientation information) for a set of particles is used to create an authentication code. For example, the generating the authentication code can include processing the spatial orientation information to derive the code. Such processing can include one or more operations such as combining, encoding, ranking, or filtering the information. In some implementations, the processing is repeatable to derive an authentication code from subsequently obtained information (e.g., from subsequently received images of a unique marker) in a standardized format.

In some implementations, an authentication code is generated based on parameterization of the shape structures. For example, in addition to using relative position and relative orientation, the authentication code can be generated using parameterization information of shape structures of the shapes corresponding to particles. In some implementations, parameterization information includes information describing the dimensions or contours of a shape/region (representing a particle). In some implementations, shape information can be used for shape matching (e.g., to compare whether two regions are for identical shapes). For example, parameterization information can include a shape context feature descriptor. For example, parameterization information can include a closed basis spline (B-spline) function. In some implementations, the parameterization information is included in geometric properties determined for a given shape (e.g., the system determines geometric properties for a shape including a centroid, one or more principal axis, and parameterization information of the shape structure).

A unique marker may be formed using one or more methods described here. In some aspects of what is described here, the unique marker can be shaped to the surface morphology of the target object. For example, the unique marker may be shaped to surface patterns, textures, or other indentations of the object. In some instances, shaping the unique marker to the surface morphology of the target object includes providing a fluid (e.g., a liquid or viscous fluid) that contains a distribution of elements (e.g., planar particles, crystalline particles, or other types of elements), and curing the fluid to form the unique marker. In some implementations, the fluid (containing the distribution of elements) cures in the surface patterns, textures, or other indentations of the object to become the unique marker. In some implementations, the fluid is transferred from a pattern of cells onto a substrate to create the unique marker.

In some aspects of what is described here, a distribution of elements (e.g., planar particles, crystalline particles, or other types of elements) may be incorporated into an uncured or semi-cured material. In some implementations, the material can be an adhesive or a sealant material, and the uncured or semi-cured material can have a gel-like consistency. The uncured or semi-cured material can be applied to the object to conformally coat one or more components of the object, or to cover or fill a seam of the object. The uncured or semi-cured material is subsequently exposed to a process (e.g., ordinary drying, curing, by exposure to an energy source (e.g. UV radiation), or another process) that causes the material to solidify, thus allowing the adhesive or sealant material (containing the distribution of elements) to gain a physically unclonable identity while maintaining its functional purpose (e.g., decorative, informative, protective, etc.) within the design of the underlying object.

In some cases, a computer system (e.g., executing computer software) may generate a unique code based on the spatial properties of particles in a unique marker. The spatial properties may be determined from data obtained by a camera or another type of optical detector.

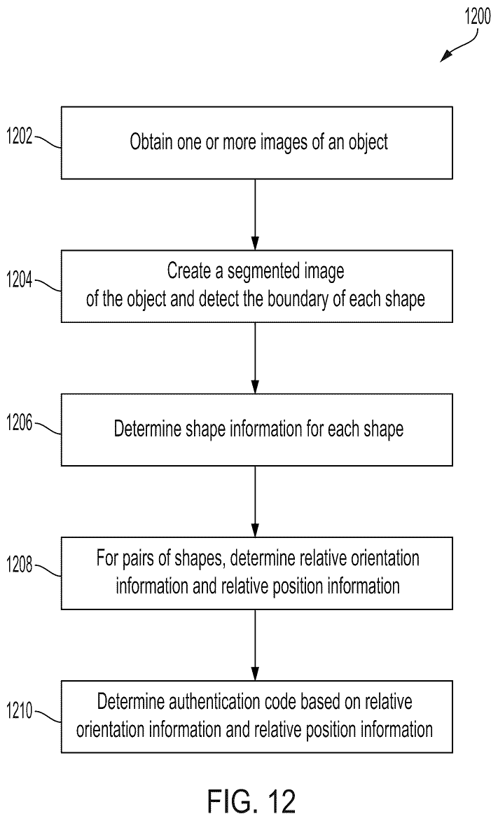

FIG. 12 is a flow chart illustrating an example process for determining a unique identifier based on one or more images of an object that includes particles. The steps of process 1200 can be performed by a system (e.g., one or more data processing apparatus, computing device, or computing system) (e.g., device 1600).

At 1202, the system obtains (e.g., captures or receives) one or more images of an object that includes a plurality of particles (e.g., 1104, 1106). For example, the image includes planar representations (e.g., projections onto an image plane) of the plurality of particles. For example, the object is a unique marker that includes the plurality of particles (e.g., 100, 200) suspended in a polymer (e.g., 200). In some implementations, the system obtains the image from another system or device (e.g., the system is in communication with an external image capturing device (e.g., 504) that provides the image obtained by the system performing process 1200). In some implementations, the system determines the unique identifier based on one or more images of the object.

At 1204, the system creates a segmented (or binary image) of the object and detects the boundary of each shape represented in the image. For example, the system performs image segmentation to identify the particles (e.g., as distinguished from the background or surrounding host material such as a polymer). Some techniques for performing image segmentation are well-known, and any such technique can be used to discern regions (e.g., shapes) within an image that correspond to particles. For example, such techniques can partition the image into discrete groups of pixels by labeling each pixel in the image, and grouping pixels that share the same characteristic based on such labels. In some implementations, the labels can be used to create a binary image in which pixels with a first label (indicating the pixel is part of a particle's planar representation in the image) are assigned a first color (e.g., black). In such implementations, pixels with a second label (indicating the pixel is not part of a particle's planar representation projection represented in the image) are assigned a second color (e.g., white). For example, a resulting binary image could include groups of black pixels (e.g., shapes) representing the projection of particles on a white background. In some embodiments, the system determines the boundaries of each shape. In some implementations, the system processes the binary image to determine shapes that may represent overlapping or touching particles. In some implementations, two particles that are not physically touching may appear overlapping or touching due to one particle occluding the other in the projection direction (e.g., resulting in their planar representations in the resulting image being one contiguous shape).

At 1206, the system determines shape information for each shape. In some embodiments, determining shape information includes determining a centroid of the shape. In some embodiments, determining shape information includes determining one or more principal axes of the shape. In some embodiments, determining relative position and relative orientation information includes performing one or more operations of process 1300.

At 1208, the system determines relative position information and relative orientation information for pairs of shapes. For example, the system determines relative position and orientation information for each unique pair of shapes detected in the image (e.g., using the binary image derived from the image). In some embodiments, determining shape information includes performing one or more operations of process 1400.

At 1210, the system determines an authentication code from the relative position information and relative orientation information. For example, the authentication code can be a collection (e.g., array, object, or any other arrangement of data) of the relative position information and relative orientation information for each pair of shapes. In some implementations, the authentication code is created by applying a transformation or function to data (e.g., the relative position information and relative orientation information).

In some implementations, the authentication code is unique can be used to verify the authenticity of the object (e.g., the unique marker or an article to which it is affixed). For example, due to random arrangement and shapes of elements (and relationships between each), the authentication code derived from the image of the elements can be considered unique and unclonable. In some implementations, a second subsequent scan (e.g., along the same imaging plane) should result in the same authentication code being derived, verifying the authenticity or indicating no tampering has occurred. In some implementations, a subsequent scan results in a substantially similar authentication code being derived (e.g., due to slight variations in visibility of the object, changes to the object, or other factors). In some cases, the substantially similar code is deemed acceptable according to a threshold or metric (e.g., if greater than 99% of the code matches, the remaining variation is excused as acceptable error). In some implementations, a unique code derived from a scan is checked against a reference code (e.g., created previously by an entity performing the scanning or by a trusted third-party authentication entity).

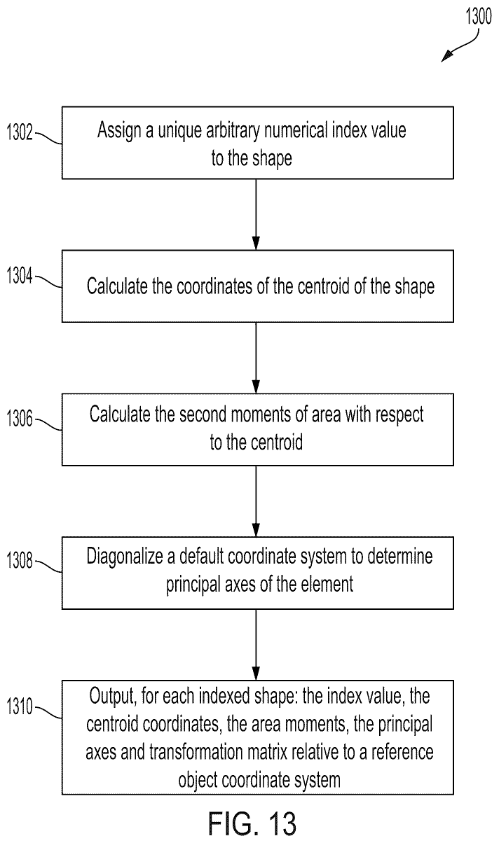

FIG. 13 is a flow chart illustrating an example process for determining shape information based on one or more images of an object that includes particles. The steps of process 1300 can be performed by a system (e.g., one or more data processing apparatus, computing device, or computing system) (e.g., device 1600). In some implementations, process 1300 is performed for each shape detected in an image (e.g., processed according to process 1200).

At 1302, the system assigns a unique arbitrary index value to the shape. For example, when multiple shapes are processed, each can receive a unique index value (e.g., 1, 2, 3, . . . , or n). At 1304, the system calculates a centroid of the shape. In some implementations, the centroid is represented as a set of coordinates with respect to a reference coordinate system. At 1306, the system calculates the second moments of area of the shape with respect to the centroid. At 1308, the system diagonalizes a default coordinate system to get the principal axes of the element. At 1310, the system outputs (e.g., stores or provides to one or more other operations of a process), for each indexed shape: the index value, the centroid coordinate, the second moments of area, the principal axes, and a transformation matrix relative to the reference coordinate system. In some implementations, the output for each shape includes some of these values, other values, or a combination of both.

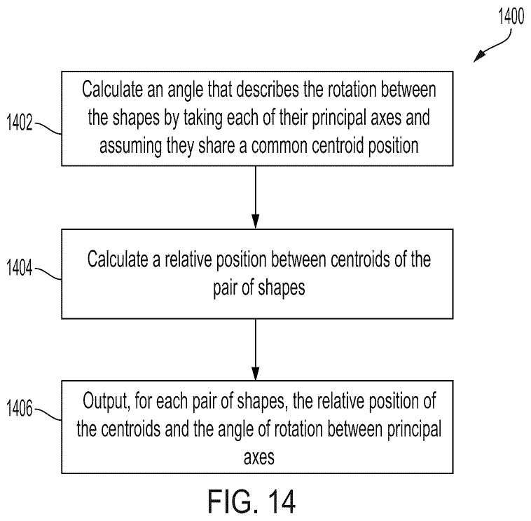

FIG. 14 is a flow chart illustrating an example process for determining relative position information and relative orientation information for a pair of shapes representing particles. The steps of process 1400 can be performed by a system (e.g., one or more data processing apparatus, computing device, or computing system) (e.g., device 1600). In some implementations, process 1400 is performed for unique pairs of shapes detected in an image (e.g., processed according to process 1200 or process 1300). In some implementations, the system determines relative position information and relative orientation information based on one or more images of the object.

At 1402, the system calculates a relative orientation between principal axes of a pair of shapes. For example, the systems determines an angle formed between the major principal axis of a first shape and the major principal axis of a second shape when the centroids of the first and second shapes are aligned (e.g., the respective origins of each principal coordinate axes are the same).

At 1404, the system calculates a relative position between centroids of the pair of shapes. In some implementations, relative position is a displacement or translation with respect to a reference coordinate system (e.g., canonical coordinate system assigned to the object or image). For example, the displacement includes a value for displacement in the x-direction and a value for displacement in the y-direction.

At 1406, the system outputs (e.g., stores or provides to one or more other operations of a process), for each pair of shapes: the relative position information and relative orientation information. In some implementations, the output for each shape pair includes some of these values, other values, or a combination of both.

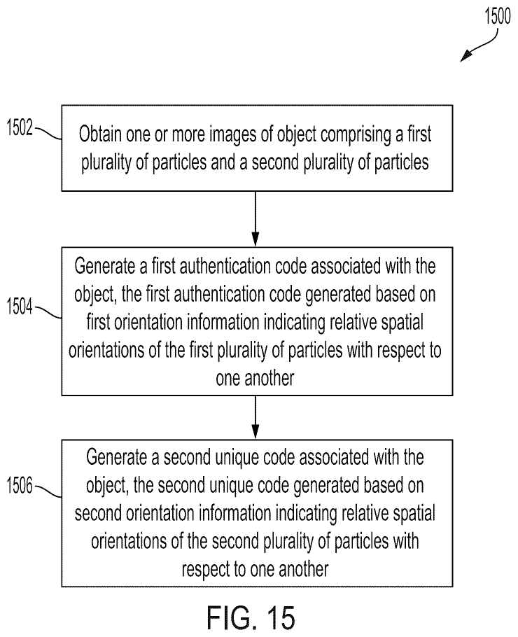

FIG. 15 is a flow chart illustrating an example process for determining two authentication codes based on one or more images of an object that includes particles each having sub-elements. The steps of process 1500 can be performed by a system (e.g., one or more data processing apparatus, computing device, or computing system) (e.g., device 1600).

At 1502, the system obtains one or more images of an object comprising a first plurality of particles, and a second plurality of particles. For example, the object can include (or be) a multiscale marker that includes a first class of particles having a first characteristic size (e.g., 1 cm×1 cm) and a second class of particles having a second characteristic size (e.g., 0.1 mm×0.1 mm). In some examples, the first plurality and second plurality can be distributed in or on a host material separately (e.g., the second plurality occupying interstitial spaces between the first plurality). In some examples, the second plurality can be distributed on (e.g., affixed to) one or more surfaces of the first plurality of particles.

At 1504, the system generates a first authentication code associated with the object, the first authentication code generated based on first orientation information extracted from the one or more images, and the first orientation information indicating relative spatial orientations of the first plurality of particles with respect to one another. For example, the system generates the first authentication code according to one or more of processes 1200, 1300, and 1400.

At 1506, the system generates a second authentication code associated with the object, the second authentication code generated based on second orientation information extracted from the one or more images, and the second orientation information indicating relative spatial orientations of the second plurality of particles with respect to one another. In some implementations, the system generates the second authentication code according to one or more of processes 1200, 1300, and 1400. In some implementations, the system generates the second authentication code according to a different process than to generate the first authentication code. For example, the object can be a multiscale unique marker that includes crystalline diamond particles as the second plurality of particles. In such example, characteristics of (e.g., relationships between) the diamond particles can be quantified (e.g., imaged, sensed, and processed) and used to generate the second authentication code. For example, characteristics of diamond particles can be determined using magnetic resonance imaging or fluorescence scanning. In some implementations, the second plurality of particles can be any extended object in three dimensions (e.g., and not necessarily crystalline in nature).

The processes described here (e.g., 1200, 1300, 1400, and 1500), or portions thereof, can be performed together in a variety of combinations. Such combinations can include some or all portions of any of the processes and can be performed in a different order than what may be explicitly described here.

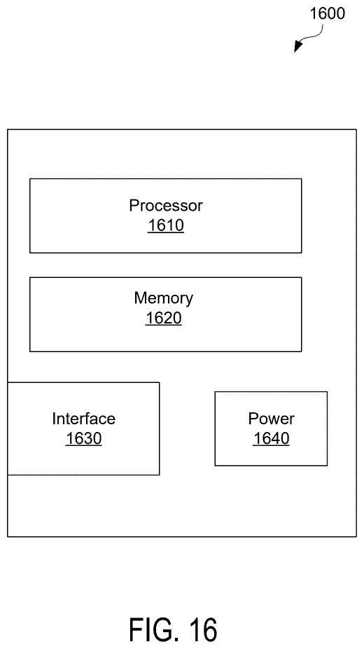

FIG. 16 illustrates a block diagram showing an example device 1600. As shown in FIG. 16, the example device 1600 includes an interface 1630, a processor 1610, a memory 1620, and a power unit 1640. A device may include additional or different components, and the device 1600 may be configured to operate as described with respect to the examples above. In some implementations, the interface 1630, processor 1610, memory 1620, and power unit 1640 of a device are housed together in a common housing or other assembly. In some implementations, one or more of the components of a device can be housed separately, for example, in a separate housing or other assembly. Device 1600 can also be referred to as system 1600 or computer system 1600.

The example interface 1630 can communicate (receive, transmit, or both) wireless signals. For example, the interface 1630 may be configured to communicate radio frequency (RF) signals formatted according to a wireless communication standard (e.g., Wi-Fi, 4G, 5G, Bluetooth, etc.). In some implementations, the example interface 1630 includes a radio subsystem and a baseband subsystem. The radio subsystem may include, for example, one or more antennas and radio frequency circuitry. The radio subsystem can be configured to communicate radio frequency wireless signals on the wireless communication channels. As an example, the radio subsystem may include a radio chip, an RF front end, and one or more antennas. The baseband subsystem may include, for example, digital electronics configured to process digital baseband data. In some cases, the baseband subsystem may include a digital signal processor (DSP) device or another type of processor device. In some cases, the baseband system includes digital processing logic to operate the radio subsystem, to communicate wireless network traffic through the radio subsystem or to perform other types of processes.

The example processor 1610 can execute instructions, for example, to generate output data based on data inputs. The instructions can include programs, codes, scripts, modules, or other types of data stored in memory 1620. Additionally, or alternatively, the instructions can be encoded as pre-programmed or re-programmable logic circuits, logic gates, or other types of hardware or firmware components or modules. The processor 1610 may be or include a general-purpose microprocessor, as a specialized co-processor or another type of data processing apparatus. In some cases, the processor 1610 performs high level operation of the device 1600. For example, the processor 1610 may be configured to execute or interpret software, scripts, programs, functions, executables, or other instructions stored in the memory 1620. In some implementations, the processor 1610 may be included in the interface 1630 or another component of the device 1600.

The example memory 1620 may include (e.g., non-transitory) computer-readable storage media, for example, a volatile memory device, a non-volatile memory device, or both. The memory 1620 may include one or more read-only memory devices, random-access memory devices, buffer memory devices, or a combination of these and other types of memory devices. In some instances, one or more components of the memory can be integrated or otherwise associated with another component of the device 1600. The memory 1620 may store instructions that are executable by the processor 1610. For example, the instructions may include instructions to perform one or more of the operations in the example processes described herein, for example, such as those described with respect to FIGS. 1-15.

The example power unit 1640 provides power to the other components of the device 1600. For example, the other components may operate based on electrical power provided by the power unit 1640 through a voltage bus or other connection. In some implementations, the power unit 1640 includes a battery or a battery system, for example, a rechargeable battery. In some implementations, the power unit 1640 includes an adapter (e.g., an AC adapter) that receives an external power signal (from an external source) and coverts the external power signal to an internal power signal conditioned for a component of the device 1600. The power unit 1620 may include other components or operate in another manner.

In some implementations, device 1600 includes additional components. For example, device 1600 can include one or more imaging device (e.g., camera, imaging sensor, and optics).

Accordingly, some of the subject matter and operations described in this specification can be implemented in digital electronic circuitry, or in computer software, firmware, or hardware, including the structures disclosed in this specification and their structural equivalents, or in combinations of one or more of them. Some of the subject matter described in this specification can be implemented as one or more computer programs, i.e., one or more modules of computer program instructions, encoded on a computer storage medium for execution by, or to control the operation of, data-processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

Some of the operations described in this specification can be implemented as operations performed by a data processing apparatus on data stored on one or more computer-readable storage devices or received from other sources.

The term “data-processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. A data-processing apparatus can include one or more devices such as device 1600.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

In some aspects of what is described here, a unique marker that includes a distribution of elements can be used to demonstrate evidence of tampering with or use of a tagged object.

The systems and techniques described here can provide technical advantages and improvements. In some examples, a unique marker can include a distribution of particles, and a unique code corresponding to the unique marker can be derived from planar representations of the distribution of particles. Using planar representations of a distribution of particles can simplify the process of generating an authentication code, while preserving other desired features (e.g., uniqueness, unclonability, etc.). In some cases, using planar representations of two-dimensional elements can simplify a manufacturing process or allow the unique marker to be deployed using different types of materials (e.g., less expensive materials or materials that are more abundant or accessible or physically robust), using different types of substrates, having different sizes or form factors, or a combination of these and other advantages.

In a general aspect, a method for generating an authentication code identifier includes receiving a target object and forming a unique marker on a surface of the target object. The unique marker may include a plurality of particles and may conform to the surface. The method may also include extracting spatial information from the unique marker. The spatial information may represent the positions and orientations of the particles relative to each other. The method may additionally include generating an authentication code for the target object based on the spatial information. In some implementations, the spatial information includes two-dimensional spatial information. In these implementations, the two-dimensional spatial information may represent the relative positions and orientations of particles that are adjacent to the planar surface.

In a general aspect, an authentication code associated with an object is generated.

In a first example, a method is performed by a computing system (e.g., 1600). The method includes obtaining one or more images of an object comprising a plurality of particles (e.g., 100A, 100B, 400). The method includes identifying regions (e.g., shapes 508, 512, 700, 902, 904) in the one or more images that correspond to the plurality of particles. The method includes determining, based on the one or more images, borders of the regions that correspond to the plurality of particles. The method includes determining, based on the borders, geometric properties of the regions that correspond to the plurality of particles, the geometric properties of each region including a centroid (e.g., 406, 902A, 904A) and a principal axis (e.g., 402, 404). The method includes determining, based on the geometric properties, orientation information for pairs of the regions in the one or more images, the orientation information for each pair indicating a relative orientation (e.g., 910, 912) of the principal axis of a first region with respect to the principal axis of a second region. The method includes determining, based on the geometric properties, position information for the pairs of regions in the one or more images, the position information for each pair indicating a relative distance (e.g., 906, 908) between the centroid of the first region and the centroid of the second region. The method includes generating an authentication code associated with the object, the authentication code generated based on the orientation information and the position information.

Implementations of the first example may include one or more of the following features. The relative distance includes a displacement (e.g., 906) along a first axis and a displacement (e.g., 908) along a second axis orthogonal to the first axis. The orientation information includes an angle of rotation (e.g., 910, 912) measured between the principal axis of the first region and the principal axis of the second region when the centroids of the first region and the second region are aligned. The geometric properties of each region include a transformation matrix relative to a reference coordinate system. The authentication code includes the position information and the orientation information. The plurality of particles is a plurality of elongated particles. The plurality of particles is a plurality of planar particles. Surface normal vectors (e.g., for the planar surfaces) for the plurality of particles are parallel and the orientation information expresses relative orientation with respect to a single plane. Surface normal vectors (e.g., for the planar surfaces) for at least some of the plurality of particles are tilted relative to, and are not parallel to, a surface normal vector of a plane corresponding to the surface of the object, wherein the geometric properties for regions corresponding to the at least some of the plurality of particles are determined based on projections of respective particles onto the plane corresponding to the surface of the object. Surface normal vectors (e.g., for the planar surfaces) for at least some of the plurality of particles are tilted relative to, and are not parallel to, a surface normal vector of a plane corresponding to the surface of the object, wherein the orientation information includes relative orientations of the surface normal vectors (e.g., for the planar surfaces) for the at least some of the plurality of particles relative to the surface normal vector of the plane corresponding to the surface of the object. One or more of the regions that correspond to the plurality of particles are closed polygons that have shape structures that can be concave or convex (e.g., for particles that are planar in nature). The authentication code is generated based on parameterization of the shape structures. The plurality of particles are non-uniform in size. Obtaining the one or more images includes causing an image capturing component (e.g., 504) in communication with the computing system to capture the one or more images. Generating the authentication code includes performing operations on the orientation information and the position information, the operations including one or more of: encoding, ranking, and filtering. The plurality of particles is a plurality of elongated particles.

In a second example, a method is performed by a computing system (e.g., 1600). The method includes obtaining one or more images of an object (e.g., a multiscale unique marker) comprising: a first plurality of particles (e.g., 100A, 100B, 400), and a second plurality of particles (e.g., 410). The method includes generating a first authentication code associated with the object, the first authentication code generated based on first orientation (e.g., one or more of 906, 908, 910, and 912) information extracted from the one or more images, and the first orientation information indicating relative spatial orientations of the first plurality of particles with respect to one another. The method includes generating a second authentication code associated with the object, the second authentication code generated based on second orientation information (e.g., one or more of 906, 908, 910, and 912) extracted from the one or more images, and the second orientation information indicating relative spatial orientations of the second plurality of particles with respect to one another.

Implementations of the second example may include one or more of the following features. The first plurality of particles have one or more representative characteristics that are different from the second plurality of particles. The one or more representative characteristics includes one or more of: characteristic size; shape; material; color; and spectral reflectance. The first plurality of particles are a same type of particle as the second plurality of particles. The first plurality of particles are a distinct type of particle from the second plurality of particles. The second plurality of particles are located on one or more surfaces of the first plurality of particles. The first plurality of particles and the second plurality of particles are distributed in or on a host material. The first authentication code and the second authentication code are generated based on the same image of the one or more images. The first authentication code and the second authentication code are generated based on different images of the one or more images. The method includes: identifying regions in the one or more images that correspond to the first plurality of particles; determining, based on the one or more images, borders of the regions that correspond to the first plurality of particles; and determining, based on the borders, geometric properties of the regions that correspond to the first plurality of particles, the geometric properties of each region including a centroid and a principal axis. The method includes determining, based on the geometric properties, the first orientation information including determining orientation information for pairs of the regions in the one or more images, the orientation information for each pair indicating a relative orientation of the principal axis of a first region with respect to the principal axis of a second region. The method includes determining, based on the geometric properties, position information for the pairs of the regions in the one or more images, the position information for each pair indicating a relative distance between the centroid of the first region and the centroid of the second region. Generating the first authentication code is based on the first orientation information and the position information. The method includes generating a composite authentication code (e.g., multiscale authentication code) based on the first authentication code and the second authentication code. The first plurality of particles are macroscopic. The second plurality of particles are microscopic. The first plurality of particles are planar bodies. The second plurality of particles are planar bodies. The second plurality of particles are non-planar bodies. The second plurality of particles are crystalline particles. The crystalline particles are diamond particles. The method includes: causing a check of the first authentication code against a first reference code; and outputting a check result indicating whether the first authentication code matches the first reference code. The method includes: causing a check of the second authentication code against a second reference code; and outputting a check result indicating whether the second authentication code matches the second reference code. Obtaining the one or more images includes causing an image capturing component (e.g., 504) in communication with the computing system to capture the one or more images.

In a third example, a computing system includes one or more processors and a computer-readable medium storing instructions that are operable when executed by the one or more processors to perform one or more operations of the first example or the second example.

In a fourth example, a non-transitory computer-readable medium storing instructions that are operable when executed by a data-processing apparatus to perform one or more operations of the first example or the second example.

In a fifth example, an authentication marker for verification of an object includes: a host material (e.g., 202) (e.g., a polymer); a first plurality of particles (e.g., 100, 100A, 100B, 200, 300, 400), the first plurality of particles distributed with respect to (e.g., in or on) (e.g., suspended within) (e.g., distributed on the surface of) the host material; and a second plurality of particles (e.g., 100, 100A, 100B, 200, 300, 400, 410), the second plurality of particles distributed with respect to the host material.

Implementations of the fifth example may include one or more of the following features. The first plurality of particles have one or more representative characteristics that are different from the second plurality of particles. The one or more representative characteristics includes one or more of: characteristic size (e.g., centimeter scale, millimeter scale, or other scale); shape (e.g., square, circle, diamond, dart, ellipsoid, or non-uniform); material; color; and spectral reflectance. The first plurality of particles are a same type (e.g., material, shape, or properties) of particle as the second plurality of particles. The first plurality of particles are a distinct type of particle from the second plurality of particles. The second plurality of particles are located on (e.g., affixed to or formed on) one or more surfaces of the first plurality of particles. The first plurality of particles and the second plurality of particles are distributed in or on the host material. The first plurality of particles are macroscopic. The second plurality of particles are microscopic. The first plurality of particles are planar bodies. The second plurality of particles are planar bodies. The second plurality of particles are non-planar bodies. The second plurality of particles are crystalline particles. The crystalline particles are diamond particles. The host material is a polymer. The first plurality of particles is (or includes) a plurality of elongated particles. The second plurality of particles is (or includes) a plurality of elongated particles.

While this specification contains many details, these should not be understood as limitations on the scope of what may be claimed, but rather as descriptions of features specific to particular examples. Certain features that are described in this specification or shown in the drawings in the context of separate implementations can also be combined.

Conversely, various features that are described or shown in the context of a single implementation can also be implemented in multiple embodiments separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

1. A method performed by a computing system, the method comprising:
obtaining one or more images of an object comprising a plurality of particles;
identifying regions in the one or more images that correspond to the plurality of particles;
determining, based on the one or more images, borders of the regions that correspond to the plurality of particles;
determining, based on the borders, geometric properties of the regions that correspond to the plurality of particles, the geometric properties of each region including a centroid and a principal axis;
determining, based on the geometric properties, orientation information for pairs of the regions in the one or more images, the orientation information for each pair indicating a relative orientation of the principal axis of a first region with respect to the principal axis of a second region;
determining, based on the geometric properties, position information for the pairs of regions in the one or more images, the position information for each pair indicating a relative distance between the centroid of the first region and the centroid of the second region; and
generating an authentication code associated with the object, the authentication code generated based on the orientation information and the position information.

2. The method of claim 1, wherein the relative distance includes a displacement along a first axis and a displacement along a second axis orthogonal to the first axis.

3. The method of claim 1, wherein the orientation information includes an angle of rotation measured between the principal axis of the first region and the principal axis of the second region when the centroids of the first region and the second region are aligned.

4. The method of claim 1, wherein the geometric properties of each region include a transformation matrix relative to a reference coordinate system.

5. The method of claim 1, wherein the authentication code includes the position information and the orientation information.

6. The method of claim 1, wherein the plurality of particles is a plurality of elongated particles.

7. The method of claim 1, wherein the plurality of particles is a plurality of planar particles.

8. The method of claim 7, wherein surface normal vectors for the plurality of planar particles are parallel and the orientation information expresses relative orientation with respect to a single plane.

9. The method of claim 7, wherein surface normal vectors for at least some of the plurality of planar particles are tilted relative to, and are not parallel to, a surface normal vector of a plane corresponding to the surface of the object; and
wherein the geometric properties for regions corresponding to the at least some of the plurality of planar particles are determined based on projections of respective planar particles onto the plane corresponding to the surface of the object.

10. The method of claim 7, wherein surface normal vectors for at least some of the plurality of planar particles are tilted relative to, and are not parallel to, a surface normal vector of a plane corresponding to the surface of the object; and
wherein the orientation information includes relative orientations of the surface normal vectors for the at least some of the plurality of planar particles relative to the surface normal vector of the plane corresponding to the surface of the object.

11. The method of claim 1, wherein one or more of the regions that correspond to the plurality of particles are closed polygons that have shape structures that are concave or convex.

12. The method of claim 11, wherein the authentication code is generated based on parameterization of the shape structures.

13. The method of claim 1, wherein the plurality of particles are non-uniform in size.

14. The method of claim 1, wherein obtaining the one or more images includes causing an image capturing component in communication with the computing system to capture the one or more images.

15. The method of claim 1, wherein generating the authentication code includes performing operations on the orientation information and the position information, the operations including one or more of: encoding, ranking, and filtering.

16. (canceled)

17. A computing system comprising:
one or more processors; and
a computer-readable medium storing instructions that are operable when executed by the one or more processors to perform operations comprising:
obtaining one or more images of an object comprising a plurality of particles;
identifying regions in the one or more images that correspond to the plurality of particles;
determining, based on the one or more images, borders of the regions that correspond to the plurality of particles;
determining, based on the borders, geometric properties of the regions that correspond to the plurality of particles, the geometric properties of each region including a centroid and a principal axis;
determining, based on the geometric properties, orientation information for pairs of the regions in the one or more images, the orientation information for each pair indicating a relative orientation of the principal axis of a first region with respect to the principal axis of a second region;
determining, based on the geometric properties, position information for the pairs of regions in the one or more images, the position information for each pair indicating a relative distance between the centroid of the first region and the centroid of the second region; and
generating an authentication code associated with the object, the authentication code generated based on the orientation information and the position information.

18. The computing system of claim 17, wherein the relative distance includes a displacement along a first axis and a displacement along a second axis orthogonal to the first axis.

19. The computing system of claim 17, wherein the orientation information includes an angle of rotation measured between the principal axis of the first region and the principal axis of the second region when the centroids of the first region and the second region are aligned.

20. The computing system of claim 17, wherein the authentication code includes the position information and the orientation information.

21. The computing system of claim 17, wherein obtaining the one or more images includes causing an image capturing component in communication with the computing system to capture the one or more images.

22. The computing system of claim 17, wherein generating the authentication code includes performing operations on the orientation information and the position information, the operations including one or more of: encoding, ranking, and filtering.

23. A non-transitory computer-readable medium storing instructions that are operable when executed by a data-processing apparatus to perform operations comprising:
obtaining one or more images of an object comprising a plurality of particles;
identifying regions in the one or more images that correspond to the plurality of particles;
determining, based on the one or more images, borders of the regions that correspond to the plurality of particles;
determining, based on the borders, geometric properties of the regions that correspond to the plurality of particles, the geometric properties of each region including a centroid and a principal axis;
determining, based on the geometric properties, orientation information for pairs of the regions in the one or more images, the orientation information for each pair indicating a relative orientation of the principal axis of a first region with respect to the principal axis of a second region;
determining, based on the geometric properties, position information for the pairs of regions in the one or more images, the position information for each pair indicating a relative distance between the centroid of the first region and the centroid of the second region; and
generating an authentication code associated with the object, the authentication code generated based on the orientation information and the position information.

24. The non-transitory computer-readable medium of claim 23, wherein the relative distance includes a displacement along a first axis and a displacement along a second axis orthogonal to the first axis.

25. The non-transitory computer-readable medium of claim 23, wherein the orientation information includes an angle of rotation measured between the principal axis of the first region and the principal axis of the second region when the centroids of the first region and the second region are aligned.

26. The non-transitory computer-readable medium of claim 23, wherein the authentication code includes the position information and the orientation information.

27. The non-transitory computer-readable medium of claim 23, wherein obtaining the one or more images includes causing an image capturing component in communication with the data process apparatus to capture the one or more images.

28. The non-transitory computer-readable medium of claim 23, wherein generating the authentication code includes performing operations on the orientation information and the position information, the operations including one or more of: encoding, ranking, and filtering.

29-85. (canceled)
